(19) United States
(12) Patent Application Publication
(10) Pub. No.: US 2011/0211027 A1
(43) Pub. Date: Sep. 1, 2011

(54) PRINT HEAD, PRINTER

(75) Inventors: Takahiro Miyata, Chigasaki-shi (JP); Masao Murata, Chigasaki-shi (JP); Satoshi Shiba, Chigasaki-shi (JP); Mitsuru Yahagi, Chigasaki-shi (JP); Jyunpei Yuyama, Chigasaki-shi (JP)

(73) Assignee: ULVAC, INC., Chigasaki-shi (JP)

(21) Appl. No.: 13/085,779

(22) Filed: Apr. 13, 2011

Related U.S. Application Data
(63) Continuation of application No. PCT/JP2009/067756, filed on Oct. 14, 2009.

(30) Foreign Application Priority Data
Oct. 16, 2008 (JP) 2008-267663

(51) Int. Cl. B41J 2/045

(52) U.S. Cl. 347/70

(57) ABSTRACT

Vibration is prevented from being transmitted via a fixed substrate. In order to set the resonance frequencies of the vibration of piezoelectric vibrators to be different from each other, the piezoelectric vibrators having different lengths are attached to the same fixed substrate. Even if residual vibration of a pressure generation chamber, which is expanded/contracted by a piezoelectric vibrator to which a voltage is applied, is transmitted to the fixed substrate; and even if the vibration is transmitted to another piezoelectric vibrator via the fixed substrate; another piezoelectric vibrator does not vibrate because the resonance frequencies between the piezoelectric vibrators are different from each other. Consequently, the pressure generation chamber in contact with the piezoelectric vibrator is not expanded or contracted by the vibration.

This application is a continuation of International Application No. PCT/JP2009/067756 filed Oct. 14, 2009, which claims priority to Japanese Patent Document No. 2008-267663, filed on Oct. 16, 2008. The entire disclosures of the prior applications are herein incorporated by reference in their entireties.

### BACKGROUND OF INVENTION

The present invention generally relates to a print head and a printer in which a discharge liquid is discharged from discharge orifices and the discharge liquid lands on an object to be discharged (such as, a substrate), and especially relates to a print head and a printer which are used to manufacture a liquid crystal display device, an EL display device, or the like.

### BACKGROUND ART

In recent years, an inkjet type discharge device is used to produce a color filter of a liquid crystal display device and an organic EL display device.

Reference numeral 101 in FIGS. 4(a) and 4(b) generally denotes a part of a print head of such a discharge device, reference symbol A₀ FIG. 4(a) generally denotes a schematic front view of an internal structure of the print head; and reference numeral B₀ in FIG. 4(b) generally denotes a schematic side view of the print head.

A nozzle plate 106 is provided below a housing 102 of the print head 101; and a plurality of pressure generation chambers 109 is provided in the nozzle plate 106.

A discharge orifice 110 is formed at the bottom edge of each of the pressure generation chambers 109; and the top edge thereof is connected to a common ink chamber 108 provided in the housing 102.

Each of piezoelectric vibrators 104 is disposed above the pressure generation chambers 109, respectively.

A discharge liquid is supplied from an ink tank, which is disposed outside of the print head 101 and stores the discharge liquid, to the common ink chamber 108 through a supply route 117.

The discharge liquid supplied in the common ink chamber 108 is distributed to each of the pressure generation chambers 109; and the pressure chambers 109 are filled with the discharge liquid.

An elastic plate 105 located on the pressure generation chamber 109 is exposed inside each of the pressure generation chambers 109; and the piezoelectric vibrator 104 is in contact with a surface of the elastic plate 105 on the opposite side of the exposed portion thereof.

When a voltage is applied to the piezoelectric vibrator 104 and the piezoelectric vibrator 104 vibrates, the discharge liquid is discharged from the discharge orifice 110 of the pressure generation chamber 109 with which the piezoelectric vibrator 104 is in contact.

More specifically, a concave portion is provided in the housing 102 of the print head 101, and a fixed substrate 103 is disposed in the concave portion. Each piezoelectric vibrator 104 is fixed to the fixed substrate 103. By applying a voltage to the piezoelectric vibrator 104 and vibrating the piezoelectric vibrator 104 in the longitudinal direction, the pressure generation chamber 109 expands/contracts via the elastic plate 105 and the discharge liquid stored inside the pressure generation chamber 109 is discharged toward the substrate from the discharge orifice 110.

The piezoelectric vibrators 104 are densely arranged and adhered to the fixed substrate 103 by an adhesive layer 125, so that residual vibration of the pressure generation chamber 109 which expanded/contracted causes a piezoelectric vibrator 104, to which no voltage is applied, to vibrate via the fixed substrate 103.

In this case, the piezoelectric vibrator 104, to which the vibration is transmitted, transmits the vibration to the pressure generation chamber 109 in contact with the piezoelectric vibrator 104 via the elastic plate 105, so that a cross-talk may occur, in which the discharge liquid is discharged from the pressure generation chamber.

In order to prevent such residual vibration from being transmitted, there is disclosed a technique for providing a function to absorb the residual vibration to the adhesive layer 125 between the piezoelectric vibrator 104 and the fixed substrate 103. However, this method uses physical characteristics of the adhesive layer 125, which reduces the residual vibration, so that it is estimated that the residual vibration cannot be completely eliminated. See, Japanese Unexamined Patent Application Publication No. 2000-108348.

### SUMMARY OF THE INVENTION

The present invention is invented to solve the problem relating to the above-described cross-talk, and the present invention provides an inkjet type discharge device and print head which realize stable liquid drop discharge performance by preventing the residual vibration of the pressure generation chamber from being transmitted to another pressure generation chamber via the piezoelectric vibrator and the fixed substrate.

To solve the above problem, the present invention is directed toward a print head which includes a plurality of piezoelectric vibrators having a longitudinal direction, and in which the piezoelectric vibrators, when vibrating in the longitudinal direction, expand/contract different pressure generation chambers, respectively, to discharge a discharge liquid from a discharge orifice provided in each of the pressure generation chambers, wherein resonance frequencies of vibration of the respective piezoelectric vibrators are set to be different from each other.

Further, the present invention is directed toward a print head in which the piezoelectric vibrators are formed such that the lengths thereof in the longitudinal direction are different from each other.

Further, the present invention is directed toward a print head in which one end of each of the piezoelectric vibrators is in contact with the discharge liquid inside the pressure generation chamber via an elastic member; and the other end thereof is attached to a fixed substrate by an adhesive layer.

Further, the present invention is directed toward a print head in which one end of each of the piezoelectric vibrators is in contact with the discharge liquid inside the pressure generation chamber via an elastic member, and the other end thereof is attached to a fixed substrate by an adhesive layer.

Further, the present invention is directed toward a printer which includes a substrate stage on which a substrate as an object to be discharged is disposed, and any one of the above-described print heads, wherein the substrate stage and the print head are configured so as to be able to move relative to each other; and the discharge liquid discharged from the print head is configured so as to land on the substrate.

Further, the present invention is directed toward a printer in which, in the print head, the piezoelectric vibrators are formed such that the lengths thereof in the longitudinal direction are different from each other.

Further, the present invention is directed toward a printer in which, in the print head, one end of each of the piezoelectric vibrators is in contact with the discharge liquid inside the pressure generation chamber via an elastic member, and the other end thereof is attached to a fixed substrate by an adhesive layer.

Further, the present invention is directed toward a printer in which, in the print head, one end of each of the piezoelectric vibrators is in contact with the discharge liquid inside the pressure generation chamber via an elastic member, and the other end thereof is attached to a fixed substrate by an adhesive layer.

### EFFECTS OF THE INVENTION

Even when a vibration of another vibrator is applied to a vibrator in a stationary state, the vibrator in a stationary state vibrates only a little, so that no cross-talk occurs.

### BRIEF DESCRIPTION OF THE DRAWINGS

FIG. 1 is an example of a printer of the present invention.

Reference symbol A₁ in FIG. 2(a) denotes an internal front view of a print head of an example of the present invention.

Reference symbol B₁ in FIG. 2(b) denotes an internal side view of the print head.

Reference symbol A₂ in FIG. 3 denotes an internal front view of a print head of another example of the present invention.

Reference symbol A₀ in FIG. 4(a) denotes an internal front view of a print head of the conventional art.

Reference symbol B₀ in FIG. 4(b) denotes an internal side view of the print head of the conventional art.

### DETAILED DESCRIPTION OF THE INVENTION

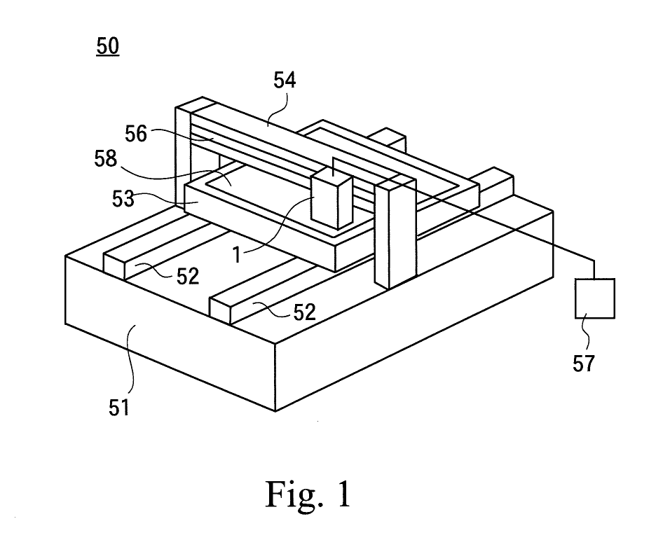

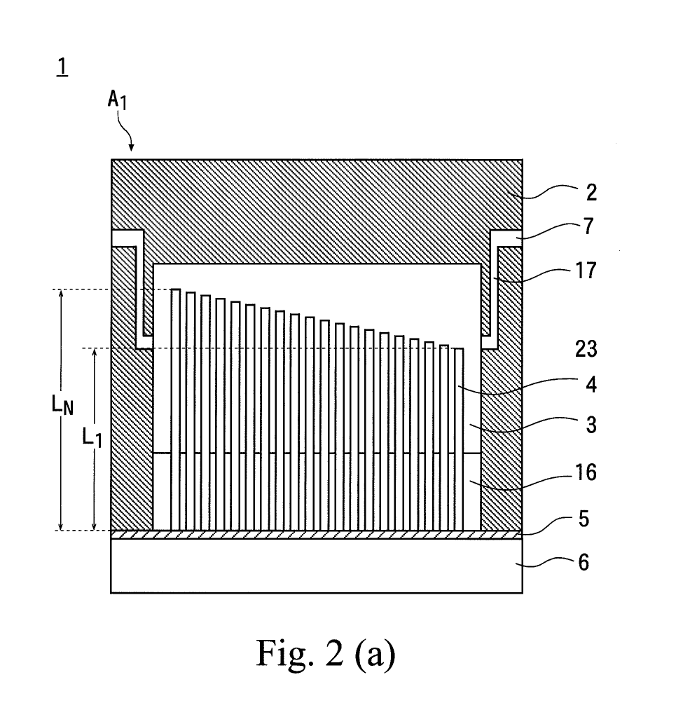

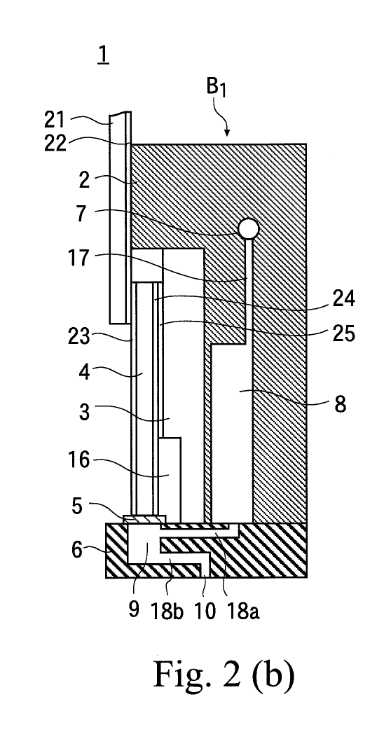

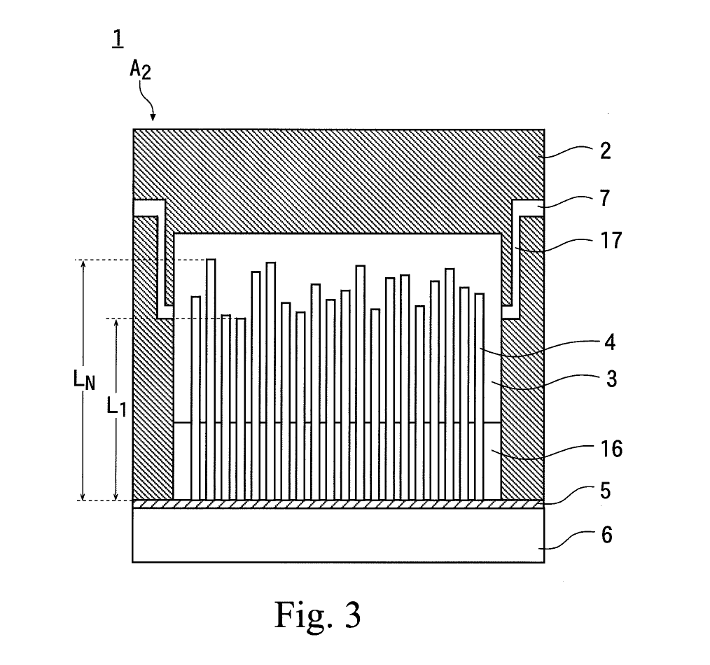

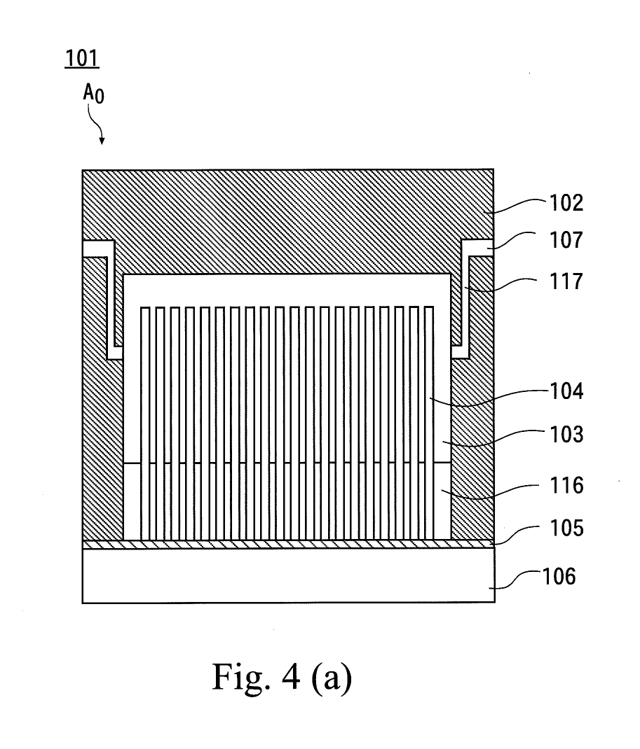

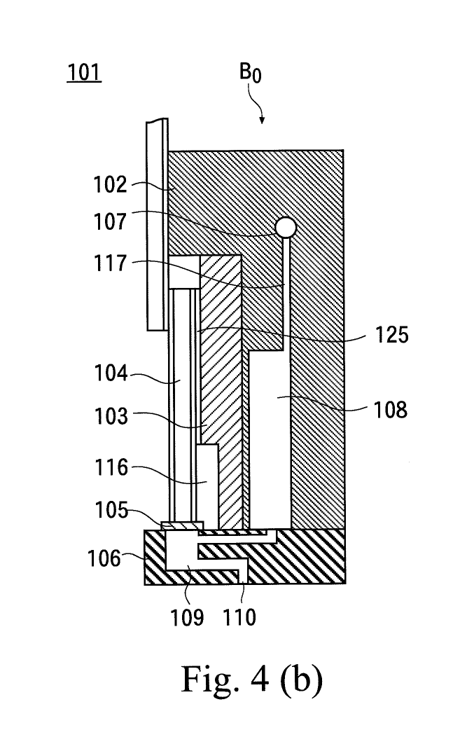

Reference numeral 50 in FIG. 1 denotes a printer of an example of the present invention.

The printer 50 includes a pedestal 51, and a substrate stage 53 is disposed on the pedestal 51 via a stage moving device 52. A device to move the substrate stage 53 is provided on the stage moving device 52, and the substrate stage 53 can reciprocate on the pedestal 51.

A bridge 54 is disposed above a moving range of the substrate stage 53. A head moving device 56 is provided to the bridge 54; and a print head 1 is movably attached to the head moving device 56. A device to move the print head 1 is provided to the head moving device 56; and the print head 1 can reciprocate above the substrate stage 53 in a direction perpendicular to the reciprocating direction of the substrate stage 53.

A discharge liquid tank 57 in which the discharge liquid is stored is provided in the printer 50.

The discharge liquid tank 57 is connected to the print head 1; and as described later, the print head 1 is configured so that the print head 1 can be supplied with the discharge liquid from the discharge liquid tank 57 and can discharge the discharge liquid.

Reference numeral 58 denotes a substrate as an object to which the discharge liquid is discharged, and the substrate is disposed on the substrate stage 53. The print head 1 can be moved to a desired position above the substrate 58 by relatively moving the print head 1 and the substrate stage 53; and in this state, when a discharge signal is output to the print head 1 from a control device not shown in the figures, the discharge liquid is discharged from the print head 1, so that it is possible to land the discharge liquid at a desired position on the surface of the substrate 58.

Reference symbol A₁ in FIG. 2(a) denotes an internal front view of the print head 1; and reference symbol B₁ in FIG. 2(b) denotes an internal side view.

An internal structure of the print head 1 will be described here. The print head 1 includes a housing 2; and a nozzle plate 6 is attached to the housing 2. Here, the nozzle plate 6 is attached to the bottom edge of the housing 2 so that a surface of the nozzle plate 6, which faces downward, can face toward the substrate stage 53.

A plurality of pressure generation chambers 9 is provided inside the nozzle plate 6; and a common ink chamber 8 is provided inside the housing 2.

A connection path 18a having one end connected to a different pressure generation chamber 9 and the other end connected to the common ink chamber 8 is provided inside the nozzle plate 6; and a supply path 17 which connects the common ink chamber 8 to a pipe 7 connected to the discharge liquid tank 57 is provided inside the housing 2.

The discharge liquid, which passes through the pipe 7 and the supply path 17 and is supplied to the common ink chamber 8 from the discharge liquid tank 57, is distributed to each pressure generation chamber 9 by the connection path 18a.

An opening is formed in a portion of the nozzle plate 6 on the side of the housing 2, which is a wall surface of the pressure generation chamber 9; the opening is closed by an elastic member 5, such as an elastic plate or an elastic film (here, a metallic film having 5 μm in the thickness); and when the discharge liquid is supplied into the pressure generation chamber 9 and the pressure generation chamber 9 is filled with the discharge liquid in a state in which gas is removed from the inside of the pressure generation chamber 9, the elastic member 5 comes into contact with the discharge liquid.

The print head 1 includes a plurality of elongated piezoelectric vibrators 4, and one end of each of the piezoelectric vibrators 4 is in contact with a surface of the elastic member 5 on a surface opposite to the surface in contact with the discharge liquid in the pressure generation chamber 9.

Electrodes 23 and 24 are formed on the front surface and the rear surface of the piezoelectric vibrator 4, respectively.

A circuit board 21 is attached to the housing 2, and a circuit electrode 22 formed at the circuit board 21 is in contact with and electrically connected to the electrodes 23 and 24 of the piezoelectric vibrator 4; and it is possible to apply a voltage between the electrodes 23 and 24 on the front surface and the rear surface of the piezoelectric vibrator 4.

A fixed substrate 3 is fixed to the housing 2, and each piezoelectric vibrator 4 is adhered to the fixed substrate 3 by an adhesive layer 25 at an end of the piezoelectric vibrator on the opposite side of the elastic member 5. Each piezoelectric vibrator 4 is adhered in parallel with each other.

The fixed substrate 3 is disposed upright on the nozzle plate 6; and a part of the fixed substrate 3 on the side of the nozzle plate 6 is formed thinly in thickness, so that a gap 16 is formed between the part of the fixed substrate 3 and the piezoelectric vibrator 4.

When a voltage is applied between the front surface and the rear surface of the piezoelectric vibrator 4, each piezoelectric vibrator 4 vibrates in the longitudinal direction, and expands/contracts the volume of the pressure generation chamber 9 by convexing the elastic member 5 toward the outside of the pressure generation chamber 9 and concaving the elastic member 5 toward the inside of the pressure generation chamber 9. The portion where the piezoelectric vibrator 4 and the fixed substrate 3 are adhered together also vibrates in the longitudinal direction.

In the nozzle plate 6, a discharge orifice 10 is provided to each pressure generation chamber 9; and each discharge orifice 10 is connected to a different pressure generation chamber 9 respectively by a discharge path 18b provided inside the nozzle plate 6. When a voltage is applied to the piezoelectric vibrator 4 selected by the control device and the pressure generation chamber 9 expands/contracts, the discharge liquid in the pressure generation chamber 9 is discharged from the discharge orifice 10.

In the print head 1, the resonance frequencies of the vibration of the piezoelectric vibrators 4 disposed on the same fixed substrate 3 are different from each other; and the piezoelectric vibrators 4 having different lengths from an end in contact with the elastic member 5 to an end on the opposite side are disposed so that the piezoelectric vibrators 4 having the same resonance frequency are not disposed on the fixed substrate 3.

Therefore, even if residual vibration of a pressure generation chamber 9 which expanded/contracted by vibration of a piezoelectric vibrator 4 to which a voltage is applied is transmitted to the fixed substrate 3 and the vibration is transmitted to another piezoelectric vibrator 4, no cross-talk occurs because the vibration quantities of the piezoelectric vibrators 4 having different resonance frequencies are small.

When the lengths of the piezoelectric vibrators 4 are different from each other, the amplitude of the applied voltage and the amplitude of the vibration in the longitudinal direction are different for each piezoelectric vibrator 4. In order to discharge a constant amount of discharge liquid from each piezoelectric vibrator 4, a relationship between the amplitude of the voltage applied to each piezoelectric vibrator 4 and the amount of discharged discharge liquid is preliminarily measured; and a voltage value is obtained for each piezoelectric vibrator 4 so that the volumes of the discharge liquid landed from each discharge orifice 10 onto the substrate 58 are a constant value when the piezoelectric vibrators 4 discharge the discharge liquid for the same number of times; and thus, each piezoelectric vibrator 4 is vibrated by the obtained voltage value.

In the above example, N piezoelectric vibrators 4 having different lengths from each other are shown in FIGS. 2(a) and 2(b). When the length of the shortest piezoelectric vibrator 4 is L₁ and the length of the longest piezoelectric vibrator 4 is L_{N}, the lengths of the other piezoelectric vibrators 4 Lₖ are represented as L₁<Lₖ<L_{N}; and the piezoelectric vibrator 4 having the shortest length L₁ is disposed at one end of the

N piezoelectric vibrators 4 arranged in parallel with each other and the piezoelectric vibrator 4 having the longest length L_{N} is disposed at the other end thereof. The piezoelectric vibrators 4 having different lengths are arranged in parallel with each other in an ascending order or a descending order of the lengths.

The present invention is not limited to one in which the piezoelectric vibrators 4 are arranged in an ascending order or a descending order of the lengths as described above. As shown in a front view denoted by reference symbol A₂ in FIG. 3, the piezoelectric vibrators 4 having lengths L₁ to L_{N} different from each other so as to have different resonance frequencies may be attached to the fixed substrate 3 in a random order in parallel with each other.

What is claimed is:

1. A print head, comprising a plurality of piezoelectric vibrators having a longitudinal direction, and in which the piezoelectric vibrators, when vibrating in the longitudinal direction, expand/contract different pressure generation chambers respectively to discharge a discharge liquid from a discharge orifice provided in each of the pressure generation chambers,
wherein resonance frequencies of vibration of the respective piezoelectric vibrators are set to be different from each other.

2. The print head according to claim 1, wherein the piezoelectric vibrators are formed such that the lengths thereof in the longitudinal direction are different from each other.

3. The print head according to claim 1, wherein one end of each of the piezoelectric vibrators is in contact with the discharge liquid inside the pressure generation chamber via an elastic member, and the other end thereof is attached to a fixed substrate by an adhesive layer.

4. The print head according to claim 2, wherein one end of each of the piezoelectric vibrators is in contact with the discharge liquid inside the pressure generation chamber via an elastic member, and the other end thereof is attached to a fixed substrate by an adhesive layer.

5. A printer, comprising:
a substrate stage on which a substrate as an object to be discharged is disposed; and
a print head according to claim 1,
wherein the substrate stage and the print head are configured so as to be able to move relatively to each other, and the discharge liquid discharged from the print head is configured so as to land on the substrate.

6. The printer according to claim 5, wherein, in the print head, the piezoelectric vibrators are formed such that the lengths thereof in the longitudinal direction are different from each other.

7. The printer according to claim 5, wherein, in the print head, one end of each of the piezoelectric vibrators is in contact with the discharge liquid inside the pressure generation chamber via an elastic member, and the other end thereof is attached to a fixed substrate by an adhesive layer.

8. The printer according to claim 6, wherein, in the print head, one end of each of the piezoelectric vibrators is in contact with the discharge liquid inside the pressure generation chamber via an elastic member, and the other end thereof is attached to a fixed substrate by an adhesive layer.
